(19) United States
(12) Patent Application Publication
(10) Pub. No.: US 2010/0075217 A1
(43) Pub. Date: Mar. 25, 2010

(54) LITHIUM ION SECONDARY BATTERY AND METHOD FOR PRODUCING THE SAME

(76) Inventors: Taisuke YAMAMOTO, Nara (JP); Masaya Ugaji, Osaka (JP); Katsumi Kashiwagi, Nara (JP)

Correspondence Address: MCDERMOTT WILL & EMERY LLP, 600 13TH STREET, NW, WASHINGTON, DC, 20005-3096, US

(21) Appl. No.: 12/556,206

(22) Filed: Sep. 9, 2009

(30) Foreign Application Priority Data
Sep. 19, 2008 (JP) 2008-241280

(51) Int. Cl. H01M 6/42; H01M 4/82

(52) U.S. Cl. 429/152; 29/623.1; 29/623.5

(57) ABSTRACT

A positive electrode, a separator, and a negative electrode including an alloy-type negative electrode active material are stacked in this order, to form an electrode unit. Such electrode units are stacked with a separator interposed between each pair of the electrode units, to form a stacked electrode assembly. The stacked electrode assembly is fabricated, and the stacked electrode assembly is pressed during an initial charge and an initial discharge. As a result, a rate of increase of the thickness of the stacked electrode assembly due to a predetermined number of charge and discharge cycles becomes equal to or less than 10%. It is thus possible to obtain a lithium ion secondary battery having high capacity and high output, capable of maintaining battery performance such as charge/discharge cycle characteristics at a high level for a long time, and having long service life.

### FIELD OF THE INVENTION

The invention relates to a lithium ion secondary battery and a method for producing the same. More particularly, the invention relates mainly to an improvement in a stacked electrode assembly including an alloy-type negative electrode active material.

### BACKGROUND OF THE INVENTION

Lithium ion secondary batteries have high capacity and high energy density, and their size and weight can be easily reduced. Thus, they are widely used as the power source for electronic devices. Examples of electronic devices include cell phones, personal digital assistants (PDAs), notebook personal computers, video cameras, and portable game machines. Also, lithium ion secondary batteries are being developed for use as the power source for automobiles such as electric vehicles and hybrid vehicles, uninterruptible power supplies, etc. A typical lithium ion secondary battery includes a positive electrode containing a lithium cobalt compound, a separator comprising a polyolefin porous film, and a negative electrode containing a carbon material such as graphite.

However, as electronic devices are becoming more multi-functional and consume more power, lithium ion secondary batteries are also required to provide higher capacity and higher output. Thus, high-capacity negative electrode active materials are necessary, and alloy-type negative electrode active materials are receiving attention. Alloy-type negative electrode active materials absorb lithium by alloying with lithium. Examples of alloy-type negative electrode active materials include silicon, tin, germanium, oxides thereof, and compounds and alloys containing such materials. Alloy-type negative electrode active materials have high discharge capacities, thus being effective for heightening the capacity of lithium ion secondary batteries. For example, the theoretical discharge capacity of silicon is approximately 4199 mAh/g, which is approximately 11 times the theoretical discharge capacity of graphite.

An alloy-type negative electrode active material repeatedly expands and contracts relatively greatly due to absorption and desorption of lithium ions. Thus, a lithium ion secondary battery using an alloy-type negative electrode active material has a problem. That is, as the number of charge/discharge cycles increases, the volume of the alloy-type negative electrode active material expands greatly, thereby deforming the negative electrode and increasing the battery thickness. Further, there is also another problem. That is, the expansion of the alloy-type negative electrode active material creates gaps in the electrode assembly and causes the negative electrode active material layer to separate from the current collector, thereby impairing the charge/discharge cycle characteristics of the battery and shortening the service life of the battery.

Japanese Laid-Open Patent Publication No. 2007-258084 (hereinafter referred to as “Patent Document 1”) proposes a lithium ion secondary battery including a flat wound electrode assembly, wherein the flat portion of the flat electrode assembly is pressed in the thickness direction of the electrode assembly in performing an initial charge/discharge.

The electrode assembly of Patent Document 1 is produced by winding a positive electrode and a negative electrode containing an alloy-type negative electrode active material with a separator interposed therebetween. Patent Document 1 use a negative electrode active material layer containing silicon powder as an alloy-type negative electrode active material and a thermoplastic polyimide as a binder and having a thickness of several tens of μm.

Also, the pressure applied to the flat portion of the electrode assembly is 1.0×10⁴N/m² or more. Patent Document 1 describes that the pressure application in the initial charge/discharge prevents the battery from swelling due to repeated charge/discharge, thereby providing a lithium ion secondary battery with good charge/discharge cycle characteristics.

However, merely applying pressure to the wound electrode assembly in the initial charge/discharge is insufficient in preventing battery swelling.

An object of the invention is to provide a lithium ion secondary battery having excellent charge/discharge cycle characteristics, long service life, high capacity, and high output.

### BRIEF SUMMARY OF THE INVENTION

The invention provides a lithium ion secondary battery including a stacked electrode assembly that comprises electrode units stacked with a separator interposed between each pair of the electrode units. Each of the electrode units includes a positive electrode, a separator, and a negative electrode stacked in the thickness direction. The positive electrode includes a positive electrode active material layer containing a positive electrode active material capable of absorbing and desorbing lithium and a positive electrode current collector. The negative electrode includes a thin-film negative electrode active material layer containing an alloy-type negative electrode active material and a negative electrode current collector. A rate of increase of the thickness of the stacked electrode assembly due to a predetermined number of charge and discharge cycles is equal to or less than 10%.

Also, the invention provides a method for producing a lithium ion secondary battery, including an electrode unit preparation step, an electrode assembly preparation step, and an initial charge/discharge step.

The electrode unit preparation step is a step of stacking a positive electrode, a separator, and a negative electrode in this order in the thickness direction, thereby to form an electrode unit. The positive electrode includes a positive electrode active material layer containing a positive electrode active material capable of absorbing and desorbing lithium and a positive electrode current collector. The negative electrode includes a thin-film negative electrode active material layer including an alloy-type negative electrode active material and a negative electrode current collector. The electrode assembly preparation step is a step of stacking a plurality of electrode units produced in the above manner with a separator interposed between each pair of the electrode units, thereby to form a stacked electrode assembly. The initial charge/discharge step is a step of performing an initial charge and an initial discharge while pressing the stacked electrode assembly. As used herein “charge/discharge” refers to “charge and discharge”.

A lithium ion secondary battery of the invention has excellent charge/discharge cycle characteristics, long service life, high capacity, and high output.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic longitudinal sectional view of the structure of an electrode unit included in a lithium ion secondary battery of the invention;

FIG. 2 is a schematic perspective view of the structure of a negative electrode current collector included in the electrode unit illustrated in FIG. 1;

FIG. 3 is a schematic longitudinal sectional view of the structure of a negative electrode included in the electrode unit illustrated in FIG. 1;

FIG. 4 is a schematic side view of the structure of an electron beam deposition device; and

FIG. 5 is a schematic side view of the structure of a deposition device in another embodiment.

### DETAILED DESCRIPTION OF THE INVENTION

The inventors have diligently conducted a large number of studies to solve the problems as described above, and considered the reason why in Patent Document 1, merely applying pressure in the initial charge/discharge is insufficient in preventing battery swelling. Examples of Patent Document 1 use a negative electrode active material layer containing silicon powder as an alloy-type negative electrode active material and a thermoplastic polyimide as a binder and having a thickness of several tens of μm. The weight ratio of the silicon powder to the thermoplastic polyimide contained in the negative electrode active material layer is 90:10. Thus, the binder content is significantly higher than that of a common negative electrode active material layer containing a binder.

Thermoplastic polyimides are engineering plastics with high heat resistance and high mechanical strength. They are used as materials for flexible substrates in electronic components etc., and they are flexible and deformable to some extent in a thickness of several tens of μm. Hence, when pressure is applied in the initial charge/discharge, the thermoplastic polyimide contained in a high ratio in the negative electrode active material layer is thought to deform and function as a buffer which absorbs the expansion and contraction of the silicon powder. As a result, the application of pressure in the initial charge/discharge does not exhibit a sufficient effect. As the number of charge/discharge cycles increases, the expansion and contraction of the silicon powder is thought to increase, thereby increasing the degree of deformation and battery swelling.

Based on the above findings, the inventors have conducted further studies and found that electrode deformation and battery swelling due to the expansion and contraction of an alloy-type negative electrode active material are suppressed by merely applying pressure to an electrode assembly in the thickness direction thereof only in the initial charge/discharge when using a thin-film negative electrode active material layer free of resin binder and composed substantially of an alloy-type negative electrode active material and changing the electrode assembly from the wound-type to the stacked-type. Based on his finding, the inventors have completed the invention.

According to the invention, despite the use of an alloy-type negative electrode active material that repeatedly expands and shrinks due to charge/discharge, battery swelling are unlikely to occur even after repeated charge/discharge cycles. It is thus possible to provide a lithium ion secondary battery having high reliability, suffering little degradation of charge/discharge cycle characteristics, and having long cycle life. In addition, since the lithium ion secondary battery of the invention uses an alloy-type negative electrode active material, it has high capacity and high output compared with conventional lithium ion secondary batteries.

The lithium ion secondary battery of the invention is characterized by:

(1) using a stacked electrode assembly composed of a plurality of electrode units stacked with a separator interposed between each pair of the electrode units, each of the electrode units including a positive electrode, a separator, and a negative electrode stacked in this order; and

(2) performing an initial charge/discharge with the stacked electrode assembly pressed.

Although the reason why the invention can produce the above-described excellent effects is not yet clear, it is probably as follows

The invention uses a thin-film negative electrode active material layer free of resin binder and substantially composed only of an alloy-type negative electrode active material (hereinafter referred to as an “alloy-type active material layer”). The alloy-type active material layer is formed by a vapor deposition method such as evaporation, chemical vapor deposition, or sputtering. Thus, the thickness of the alloy-type active material layer can be made less than that of a negative electrode active material layer containing a binder as well as an alloy-type negative electrode active material (hereinafter referred to as a “binder-type active material layer”, and the thickness can be made uniform. It is therefore possible to suppress the deformation of the current collector and the whole negative electrode and the separation of the alloy-type active material layer from the current collector by a large stress locally applied to the alloy-type active material layer.

The alloy-type active material layer of the invention does not contain a binder that serves as a buffer absorbing the expansion and contraction of the alloy-type negative electrode active material. The alloy-type active material layer faces the positive electrode active material layer with the separator therebetween, and is in with the separator having similar flexibility to that of a binder. However, the separator is thin and in contact with the positive electrode active material layer, which usually has a binder content of 5% by weight or less and a relatively high surface hardness. Therefore, the separator hardly serves as a buffer that absorbs the expansion and contraction of the alloy-type negative electrode active material.

When an initial charge/discharge is performed with the alloy-type active material layer pressed, an almost uniform pressure is exerted on the whole alloy-type active material layer since the thickness of the alloy-type active material layer is uniform. During the initial charge, the alloy-type negative electrode active material expands due to absorption of lithium ions, but its expansion in the thickness direction is limited since it is pressed in the thickness direction. In this state, the shape of the alloy-type negative electrode active material upon the largest expansion is almost determined. Of course, the amount of expansion increases slightly due to repeated charge/discharge, but the shape of the alloy-type negative electrode active material upon the largest expansion determined during the initial charge/discharge is thought to be maintained throughout the service life of the battery. Therefore, even upon repeated charge/discharge, battery swelling can be suppressed.

In the case of a wound electrode assembly including an alloy-type active material layer, even if it is wound into the shape of a flat plate, it has bent portions at both ends in the width direction. If such a wound electrode assembly is pressed, the pressure applied to the alloy-type active material layer of the Bent portions may become uneven. Also, when a wound electrode assembly is pressed, the bent portions are fixed. Hence, when the wound electrode assembly is charged/discharged under pressure, the expansion and contraction of the alloy-type negative electrode active material may become uneven, resulting in electrode deformation. Therefore, in the invention, by pressing the stacked electrode assembly including the alloy-type active material layer during the initial charge/discharge, battery swelling is suppressed, thereby achieving a lithium ion secondary battery suffering little degradation of charge/discharge cycle characteristics.

The lithium ion secondary battery of the invention includes a stacked electrode assembly, and is characterized in that the rate of increase of the thickness of the stacked electrode assembly due to a predetermined number of charge/discharge cycles is 10% or less, and preferably 0.3% to 10%. If the rate of increase is more than 10%, the battery swells significantly, which may make the use of the battery difficult.

The rate of increase of the thickness of the stacked electrode assembly is obtained by the following formula:

The rate of increase of the thickness of the stacked electrode assembly (%)=[(T−T₀)/T₀]×100 wherein T₀ represents the thickness of the stacked electrode assembly when the number of charge/discharge cycles is relatively small, and T represents the thickness of the stacked electrode assembly when the number of charge/discharge cycles is relatively large.

The number of charge/discharge cycles for the thickness T₀ is preferably 1 to 10, and more preferably 1 to 3. The number of charge/discharge cycles for the thickness T is not particularly limited if it is greater than the number of charge/discharge cycles for the thickness T₀. However, the number of charge/discharge cycles for the thickness T is preferably 50 or more, and more preferably 50 to 55. It is preferable to set the rate of increase of thickness at such a number of charge/discharge cycles in the above-mentioned range. This substantially or completely eliminates significant degradation of cycle characteristics due to thickness increase caused by deformation of the electrode assembly even if the number of charge/discharge cycles becomes greater than the number for the thickness T.

The thickness of the stacked electrode assembly is measured during a charge. For example, after initial charge/discharge is performed, a charge is performed, and during the charge, the thickness of the stacked electrode assembly is measured. The measured value is the thickness of the stacked electrode assembly at the 2^{nd} charge/discharge cycle.

It should be noted that in the case of a lithium ion secondary battery including a stacked electrode assembly, the increase in the thickness of the battery is almost equivalent to the increase in the thickness of the stacked electrode assembly. Hence, by measuring the thickness of the battery, the rate of increase of thickness of the stacked electrode assembly can be obtained.

The lithium ion secondary battery of one embodiment of the invention includes, for example, a stacked electrode assembly, positive electrode leads, negative electrode leads, a housing, and a non-aqueous electrolyte.

The stacked electrode assembly can be produced by stacking a plurality of electrode units in series or parallel with a separator interposed between each pair of the electrode units. Each of the electrode units includes a positive electrode, a separator, and a negative electrode, as will be described later. The number of the electrode units stacked is preferably 2 to 100, and more preferably 4 to 20. If the stacked number is less than 2, such a battery may not have sufficient capacity and output. On the other hand, if the stacked number exceeds 100, such a battery becomes too thick and swells significantly due to repeated charge/discharge. Also, the kind of the electronic device using the battery is limited.

Preferably, the electrode unit includes a negative electrode which has a tensile strength of 3 N/mm or more and a tensile elongation rate of 0.05% or more. More preferably, the negative electrode has a tensile strength of 6 N/mm or more and a tensile elongation rate of 0.5% or more. When the tensile strength and tensile elongation rate of the negative electrode are set in this range, battery swelling is further suppressed, and freedom in designing the number of electrode units stacked increases. If at least one of the tensile strength and the tensile elongation rate is lower than the above range, the effect of further suppressing battery swelling decreases.

In this specification, the tensile strength and the tensile elongation rate of a negative electrode are measured as follows. Tensile strength is measured according to JIS Z2241. Tensile strength is calculated from the following formula:

Tensile strength (N/mm)=breaking strength (N/mm²)

of current collector per cross sectional area×thickness (mm)

of current collector

Tensile elongation rate is measured according to JIS C 2318 as follows. A negative electrode is cut to obtain a sample of 15 mm×25 mm. This sample is loaded in a tensile test machine, and pulled in the length direction at a pulling speed of 5 mm/min. The tensile elongation rate is obtained by the following formula:

The tensile elongation rate (%)=[(L−L₀)/L₀]×100

wherein L₀ represents the length (25 mm) of the sample, and L represents the length of the sample when the sample broke.

The electrode unit includes a positive electrode, a separator, and a negative electrode.

The positive electrode includes a positive electrode current collector and a positive electrode active material layer. The positive electrode current collector can be one commonly used in this field, and examples include porous or non-porous conductive substrates made of metal materials, such as stainless steel, titanium, aluminum, and aluminum alloys, or conductive resins. Examples of porous conductive substrates include mesh, net, punched sheets, lath, porous materials, foam, and fibrous sheets (e.g., non-woven fabric). Examples of non-porous conductive substrates include foil, sheets, and films. While the thickness of the conductive substrate is not particularly limited, it is commonly 1 μm to 100 μm, preferably 11 to 50 μm, more preferably 5 μm to 50 μm, and most preferably 10 μm to 30 μm.

The positive electrode active material layer is formed on one or both sides of the positive electrode current collector in the thickness direction, and contains a positive electrode active material capable of absorbing and desorbing lithium ions. The positive electrode active material layer may further contain a conductive agent, a binder, etc., in addition to the positive electrode active material.

The positive electrode active material can be one commonly used in this field, and examples include lithium-containing composite metal oxides, olivine-type lithium salts, chalcogenides, and manganese dioxide.

A lithium-containing composite oxide is a metal oxide containing lithium and one or more transition metal elements, or an oxide in which part of the transition metal element(s) of such a metal oxide may be replaced with one or more different elements. Examples of transition metal elements include Sc, Y, Mn, Fe, Co, Ni, Cu, and Cr, and preferable examples include Mn, Co, and Ni. Examples of different elements include Na, Mg, Zn, Al, Pb, Sb, and B, and preferable examples include Mg and Al. These transition metal elements and different elements can be used singly or in combination of two or more of them, respectively.

Among these positive electrode active materials, lithium-containing composite metal oxides are preferable. Examples of lithium-containing composite metal oxides include LiₓCoO₂, LiₓNiO₂, LiₓMnO₂, LiₓCo_{y}Ni_{1-y}O₂, LiₓCo_{y}A_{1-y}O_{z}, LiₓNi_{1-y}A_{y}O_{z}, LiₓMn₂O₄, and LiₓMn_{2-y}A_{y}O₄ wherein A is at least one element selected from the group consisting of Na, Mg, Sc, Y, Mn, Fe, Co, Ni, Cu, Zn, Al, Cr, Pb, Sb, V, and B, 0<x<1.2, y=0 to 0.9, and z=2.0 to 2.3. The lithium molar ratio “x” decreases/increases due to charge/discharge.

Examples of olivine-type lithium salts include LiₓPO₄ and Li₂XPO₄F wherein X is at least one selected from the group consisting of Co, Ni, Mn, and Fe. Examples of chalcogenides include titanium disulfide and molybdenum disulfide. These positive electrode active materials can be used singly or in combination of two or more of them.

The conductive agent can be one commonly used in this field, and examples include graphites such as natural graphite and artificial graphite, carbon blacks such as acetylene black, ketjen black, channel black, furnace black, lamp black, and thermal black, conductive fibers such as carbon fiber and metal fiber, carbon fluoride, metal powders such as aluminum, conductive whiskers such as zinc oxide whisker and potassium titanate whisker, conductive metal oxides such as titanium oxide, and organic conductive materials such as phenylene derivatives. These conductive agents can be used singly or in combination of two or more of them.

The binder can be one commonly used in this field, and examples include polyvinylidene fluoride, polytetrafluoroethylene, polyethylene, polypropylene, aramid resin, polyamides, polyimides, polyamide-imides, polyacrylonitrile, polyacrylic acid, polymethyl acrylates, polyethyl acrylates, polyhexyl acrylates, polymethacrylic acid, polymethyl methacrylates, polyethyl methacrylates, polyhexyl methacrylates, polyvinyl acetates, polyvinyl pyrrolidone, polyethers, polyethersulfone, polyhexafluoropropylene, styrene butadiene rubber, modified acrylic rubber, and carboxymethyl cellulose.

A copolymer including two or more monomer compounds can be used as the binder. Examples of monomer compounds include tetrafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene.

These binders can be used singly or in combination of two or more of them.

The positive electrode active material layer can be formed, for example, by applying a positive electrode mixture slurry onto a surface of the positive electrode current collector, drying it, and rollering it if necessary. The positive electrode mixture slurry can be prepared by dissolving or dispersing a positive electrode active material and, if necessary, a conductive agent, a binder, etc. in an organic solvent. As the organic solvent, it is possible to use, for example, dimethyl formamide, dimethyl acetamide, methyl formamide, N-methyl-2-pyrrolidone (NMP), dimethyl amine, acetone, and cyclohexanone.

When the positive electrode mixture slurry contains a positive electrode active material, a conductive agent, and a binder, the ratio of these three components is not particularly limited. Preferably, they should be used so that the positive electrode active material accounts for 80 to 98% by weight of the total amount of these three components, the conductive agent accounts for 1 to 10% by weight of the total amount of these three components, and the binder accounts for 1 to 10% by weight of the total amount of these three components, with the total amount being 100% by weight. The thickness of the positive electrode active material layer is selected depending on various conditions. For example, when the positive electrode active material layer is formed on each side of the positive electrode current collector, the total thickness of the positive electrode active material layers is preferably about 50 μm to 200 μm.

The negative electrode includes a negative electrode current collector and a negative electrode active material layer. The negative electrode current collector can be one commonly used in this field, and examples include porous or non-porous conductive substrates made of metal materials, such as stainless steel, nickel, copper, and copper alloys, or conductive resins. Examples of porous conductive substrates include mesh, net, punched sheets, lath, porous materials, foam, and fibrous sheets (e.g., non-woven fabric). Examples of non-porous conductive substrates include foil, sheets, and films. While the thickness of the conductive substrate is not particularly limited, it is commonly 1 μm to 100 μm, preferably 5 μm to 50 μm, more preferably 5 μm to 40 μm, and most preferably 5 μm to 30 μm.

The negative electrode active material layer includes an alloy-type negative electrode active material. The alloy-type negative electrode active material can be a known one, and examples include silicon, silicon oxides, silicon nitrides, silicon alloys, silicon compounds, tin, tin oxides, tin alloys, and tin compounds.

Examples of silicon oxides include silicon oxides represented by the formula: SiOₐ wherein 0.05<a<1.95 Examples of silicon nitrides include silicon nitrides represented by the formula: SiN_{b} where 0<b<4/3. Examples of silicon alloys include alloys of silicon and one or more different elements A. At least one selected from the group consisting of Fe, Co, Sb, Bi, Pb, Ni, Cu, Zn, Ge, In, Sn, and Ti can be used as the different element A. Silicon compounds are compounds in which part of silicon contained in silicon, silicon oxides, silicon nitrides, and silicon alloys is replaced with one or more different elements B. At least one selected from the group consisting of B, Mg, Ni, Ti, Mo, Co, Ca, Cr, Cu, Fe, Mn, Nb, Ta, V, W, Zn, C, N, and Sn can be used as the different element B.

Examples of tin oxides include SnO₂ and tin oxides represented by the compositional formula: SnO_{d} wherein 0<d<2. Examples of tin alloys include Ni—Sn alloy, Mg—Sn alloy, Fe—Sn alloy, Cu—Sn alloy, and Ti—Sn alloy. Examples of tin compounds include SnSiO₃, Ni₂Sn₄, and Mg₂Sn.

Among them, for example, silicon, tin, silicon oxides, and tin oxides are preferable, and silicon and silicon oxides are particularly preferable. These alloy-type negative electrode active materials can be used singly or in combination of two or more of them.

The thin-film negative electrode active material layer can be formed on surface(s) of the negative electrode current collector, preferably, by known vapor deposition methods (thin film formation methods) such as sputtering, evaporation, and chemical vapor deposition (CVD). A thin-film negative electrode active material layer formed by a vapor deposition method has an alloy-type negative electrode active material content of substantially 100%, thereby making it possible to provide high capacity and high output. Also, according to a vapor deposition method, the thickness of the negative electrode active material layer, and thus the thickness of the battery can be reduced compared with conventional thickness. It is thus easy, for example, to meet the demand for smaller and thinner electronic devices.

The thickness of the thin-film negative electrode active material layer is preferably 3 μm to 30 μm, and more preferably 5 μm to 20 μm. In this case, the thickness of the thin-film negative electrode active material layer can be made uniform more easily, and the effect of suppressing battery swelling increases further.

Also, a lithium metal layer may be formed on the surface of the thin-film negative electrode active material layer. The amount of lithium metal can be set to an amount corresponding to the irreversible capacity of the thin-film negative electrode active material layer stored in the initial charge/discharge. The lithium metal layer can be formed, for example, by evaporation.

The separator is interposed between the positive electrode and the negative electrode. The separator is a sheet with predetermined ion permeability, mechanical strength, insulating property, etc. Examples of the separator include porous sheets such as microporous films, woven fabric, and non-woven fabric. The microporous film may be a monolaminar film or a multi-laminar film (composite film). The monolaminar film is composed of one kind of material. The multi-laminar film (composite film) is a laminate of monolaminar films composed of the same material or a laminate of monolaminar films composed of different materials.

Various resin materials can be used as the material of the separator, but in consideration of durability, shut-down function, battery safety, etc., polyolefins such as polyethylene and polypropylene are preferred. The shut-down function as used herein refers to the function of a separator whose pores through the thickness are closed when the battery abnormally heats up, thereby suppressing the permeation of ions and shutting down the battery reaction. If necessary, the separator may be composed of a laminate of two or more layers such as a microporous film, woven fabric, and non-woven fabric.

The thickness of the separator is commonly 5 μm to 300 μm, preferably 5 μm to 40 μm, more preferably 10 μm to 30 μm, and most preferably 10 μm to 25 μm. Also, the porosity of the separator is preferably 30% to 70%, and more preferably 35% to 60%. The porosity as used herein refers to the percentage of the total volume of the pores in the separator relative to the volume of the separator.

One end of the positive electrode lead is connected to the positive electrode current collector, while the other end is drawn out of the lithium ion secondary battery through the opening of the housing. The positive electrode lead can be, for example, an aluminum lead. One end of the negative electrode lead is connected to the negative electrode current collector, while the other end is drawn out of the lithium ion secondary battery through the opening of the housing. The negative electrode lead can be, for example, a copper lead or a nickel lead.

The housing can be, for example, a metal case, a resin case, or a laminate film case. The housing has an opening through which the stacked electrode assembly, a non-aqueous electrolyte, and the like are placed therein. A gasket is a seal member for sealing the opening of the housing. The gasket may be used in combination with other common seal members. Seal members other than the gasket may be used to seal the opening of the housing. Also, without using any seal member, the opening of the housing may be directly sealed by welding and the like.

The non-aqueous electrolyte is a lithium-ion conductive non-aqueous electrolyte, and is mainly impregnated into the stacked electrode assembly. Examples of non-aqueous electrolytes include liquid non-aqueous electrolytes, gel non-aqueous electrolytes, and solid non-aqueous electrolytes (e.g., polymer solid non-aqueous electrolytes).

A liquid non-aqueous electrolyte contains a solute (supporting salt), a non-aqueous solvent, and optionally various additives. The solute is usually dissolved in the non-aqueous solvent.

The solute can be one commonly used in this field, and examples include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylates, LiCl, LiBr, LiI, LiBCl₄, borates, and imide salts.

Examples of borates include lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium bis(5-fluoro-2-olate-1-benzenesulfonic acid-O,O′)borate.

Examples of imide salts include lithium bistrifluoromethanesulfonyl imide ((CF₃SO₂)₂NLi), lithium trifluoromethanesulfonyl nonafluorobutanesulfonyl imide ((CF₃SO₂)(C₄F₉SO₂)NLi), and lithium bispentafluoroethanesulfonyl imide ((C₂F₅SO₂)₂NLi).

These solutes can be used singly or in combination of two or more of them. The amount of the solute dissolved in 1 liter of the non-aqueous solvent is desirably 0.5 to 2 mol.

The non-aqueous solvent can be one commonly used in this field, and examples include cyclic carbonic acid esters, chain carbonic acid esters, and cyclic carboxylic acid esters. Examples of cyclic carbonic acid esters include propylene carbonate and ethylene carbonate. Examples of chain carbonic acid esters include diethyl carbonate, ethyl methyl carbonate, and dimethyl carbonate. Examples of cyclic carboxylic acid esters include γ-butyrolactone and γ-valerolactone. These non-aqueous solvents can be used singly or in combination of two or more of them.

Examples of additives include additives X and additives Y. The additives X decompose on the negative electrode to form a highly lithium-ion conductive film, thereby enhancing coulombic efficiency. Examples of additives X include vinylene carbonate, 4-methyl vinylene carbonate, 4,5-dimethyl vinylene carbonate, 4-ethyl vinylene carbonate, 4,5-diethyl vinylene carbonate, 4-propyl vinylene carbonate, 4,5-dipropyl vinylene carbonate, 4-phenyl vinylene carbonate, 4,5-diphenyl vinylene carbonate, vinyl ethylene carbonate, and divinyl ethylene carbonate. Vinylene carbonate, vinyl ethylene carbonate, and divinyl ethylene carbonate are preferable. In the additives X, part of the hydrogen atoms may be replaced with fluorine atoms. These additives X can be used singly or in combination of two or more of them.

The additives Y decompose upon battery overcharge to form a coating film on the electrode surface, thereby deactivating the battery. Examples of additives Y include benzene derivatives. Examples of benzene derivatives include benzene compounds containing a phenyl group and a cyclic compound group adjacent to the phenyl group. Examples of cyclic compound groups include phenyl groups, cyclic ether groups, cyclic ester groups, cycloalkyl groups, and phenoxy groups. Examples of benzene derivatives include cyclohexyl benzene, biphenyl, and diphenyl ether. These additives Y can be used singly or in combination of two or more of them. The preferable amount of the benzene derivative is equal to or less than 10 parts by volume relative to 100 parts by volume of the non-aqueous solvent.

A gelled non-aqueous electrolyte includes a liquid non-aqueous electrolyte and a polymer material that retains the liquid non-aqueous electrolyte. The polymer material transforms a liquid into a gel. The polymer material can be one commonly used in this field, and examples include polyvinylidene fluoride, polyacrylonitrile, polyethylene oxide, polyvinyl chloride, and polyacrylate.

A solid non-aqueous electrolyte includes a solute and a polymer material. The solute can be the same material as that described above. Examples of polymer materials include polyethylene oxide (PEO), polypropylene oxide (PPO), and a copolymer of ethylene oxide and propylene oxide.

The lithium ion secondary battery of the invention can be produced, for example, as follows.

First, a positive electrode and a negative electrode are stacked with a separator interposed therebetween, to form an electrode unit. In the electrode unit, one end of a positive electrode lead is connected to the positive electrode current collector, while one end of a negative electrode lead is connected to the negative electrode current collector. Then, a plurality of electrode units are stacked with a separator interposed between each pair of the electrode units, to form a stacked electrode assembly. The stacked electrode assembly is inserted into a housing, and the other end of each positive electrode lead are drawn out of the housing. A non-aqueous electrolyte is injected in the housing. In this state, while the housing is being evacuated, the opening of the housing is welded, to obtain a battery before an initial charge/discharge.

This battery is subjected to an initial charge/discharge under pressure. At this time, the stacked electrode assembly is pressed. The method of applying pressure is not particularly limited, and examples include pressing and hydrostatic pressing.

In pressing, pressure is applied to the stacked electrode assembly mainly in the thickness direction thereof. A common press is used for pressing. The pressure is preferably 1.0×10⁴ N/m² to 5.0×10⁶ N/m². If the pressure is less than 1.0×10⁴ N/m², the effect of preventing battery swelling due to repeated charge/discharge may become insufficient, thereby promoting the likelihood of battery swelling. On the other hand, if the pressure is more than 5.0×10⁵ N/m², it may cause, for example, the active material layer to deform or separate from the current collector, thereby resulting in battery swelling and an internal short-circuit. Pressing is preferably performed at a temperature of approximately 20° C. to 60° C. for approximately 0.5 hour to 20 hours.

In hydrostatic pressing, an almost uniform pressure is applied to the whole battery. Examples of hydrostatic pressing include CIP (Cold Isostatic pressing), HIP (Hot Isostatic pressing), and hot pressing. CIP is performed, for example, at a temperature of approximately 5° C. to 5° C., and preferably approximately 10° C. to 30° C. HIP is performed with heating, for example, at 65° C. or more. Among these methods, CIP is preferable since the object to be pressed is a battery that is shaped like a flat plate, a simple device can be used, and the coating film is not required to be heat-resistant. The coating film as used herein refers to a film covering the whole object to be pressed.

Hydrostatic pressing is performed, for example, by covering the surface of a lithium ion secondary battery with a liquid proof coating film, mounting it in a hydrostatic press, and applying pressure thereto. In the case of CIP, the coating film can be made of a synthetic resin material such as polyvinyl chloride, polyethylene, or polypropylene, or a rubber material such as natural rubber or isoprene rubber. The coating film can be formed on the surface of the lithium ion secondary battery, for example, by dipping or vacuum packing. It is also possible to insert the lithium ion secondary battery into a thin metal capsule, sealing the metal capsule in a vacuum, applying electron beam welding for sealing, mounting the metal capsule into a hydrostatic press, and applying pressure. The metal capsule can be made of a material such as copper or stainless steel.

While the pressure of hydrostatic pressing (pressure applied) is not particularly limited, it is preferably 1.0×10⁴ N/m² to 5.0×10⁶ N/m². If the pressure is less than 1.0×10⁴ N/m², the effect of preventing battery swelling due to repeated charge/discharge may become insufficient, thereby promoting the likelihood of battery swelling. On the other hand, if the pressure is more than 5.0×10⁶ N/m², it may cause, for example, the active material layer to deform or separate from the current collector, thereby resulting in battery swelling and an internal short-circuit. Also, a large device becomes necessary, thereby resulting in high production costs. Hydrostatic pressing is performed, for example, at a temperature of approximately 5° C. to 50° C., preferably approximately 10° C. to 30° C., at the above-mentioned pressure for approximately 0.5 hour to 24 hours.

While the conditions of the initial charge/discharge are not particularly limited, they are, for example, as follows.

A battery under pressure is charged and discharged at an ambient temperature of 25° C. in the following conditions. First, the battery is charged at a constant current of an hour rate of 1.0 C relative to design capacity until the battery voltage reaches 4.2 V, and then charged at a constant voltage of 4.2 V until the current value decreases to an hour rate of 0.05 C. The battery is then allowed to stand for 30 minutes. Thereafter, the battery is discharged at a constant current of an hour rate of 1.0 C until the battery voltage decreases to 3.0 V.

In this way, the initial charge/discharge is applied to the lithium ion secondary battery including the stacked electrode assembly under pressure, to obtain a lithium ion secondary battery of the invention.

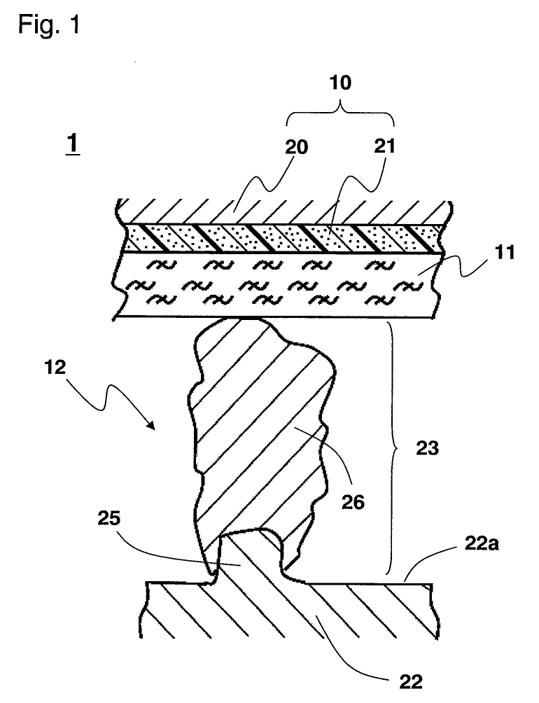

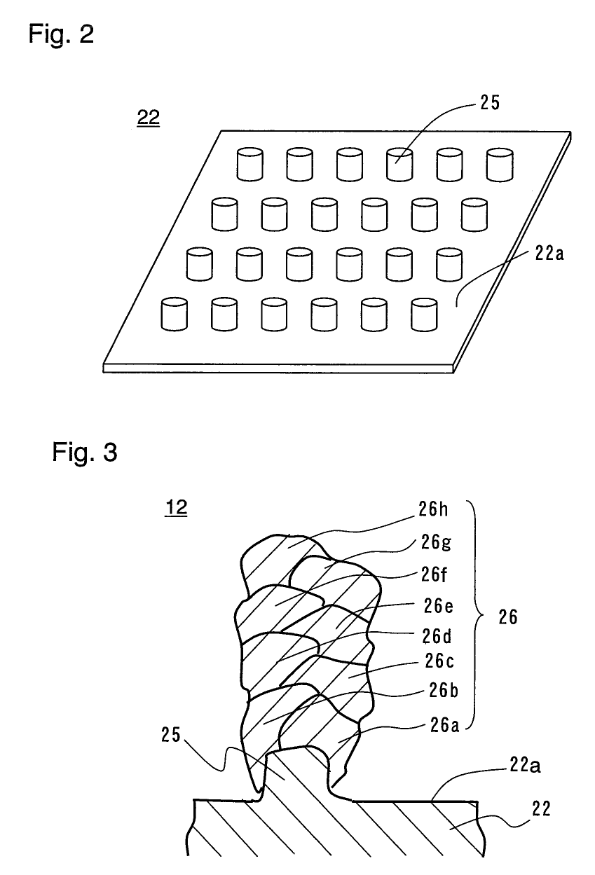

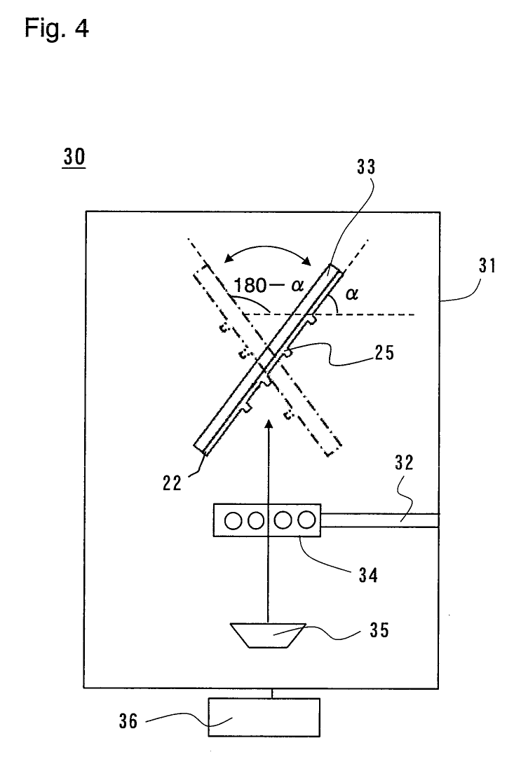

FIG. 1 is a schematic longitudinal sectional view of the structure of an electrode unit 1 included in a lithium ion secondary battery of the invention. FIG. 2 is a schematic perspective view of the structure of a negative electrode current collector 22 included in the electrode unit 1 illustrated in FIG. 1. FIG. 3 is a schematic longitudinal sectional view of the structure of a negative electrode 12 included in the electrode unit 1 illustrated in FIG. 1. FIG. 4 is a schematic side view of the structure of an electron beam deposition device 30 for producing a thin-film negative electrode active material layer 23 (hereinafter referred to as simply “negative electrode active material layer 23”).

The electrode unit 1 illustrated in FIG. 1 includes a positive electrode 10, a separator 11, and the negative electrode 12, and is characterized in that the negative electrode active material layer 23 is composed of a plurality of columns 26. There is a gap between a column 26 and an adjacent column 26. Such gaps reduce the stress created by the expansion and contraction of the columns 26. This structure serves to prevent the separator 11 and the negative electrode current collector 22 from being subjected to extra stress when the shapes of the columns 26 upon the largest expansion are determined in the initial charge/discharge under pressure. As a result, the shapes of the columns 26 upon the largest expansion become uniform, and the effect of suppressing battery swelling is further increased.

The positive electrode 10 includes a positive electrode current collector 20 and a positive electrode active material layer 21. The positive electrode current collector 20 and the positive electrode active material layer 21 have the same configurations as the above-mentioned configurations of the positive electrode current collector and the positive electrode active material layer.

The separator 11 also has the same configuration as the above-mentioned configuration of the separator.

The negative electrode 12 includes the negative electrode current collector 22 and the negative electrode active material layer 23.

As illustrated in FIG. 2, the negative electrode current collector 22 is characterized by having a plurality of protrusions 25 in one or both sides in the thickness direction.

The protrusions 25 protrude outwardly from a surface 22a of the negative electrode current collector 22 in the thickness direction (hereinafter referred to as simply “surface 22a”). The height of each of the protrusions 25 is, in the direction perpendicular to the surface 22a, the length from the surface 22a to the furthest part (outermost part) of the protrusion 25 from the surface 22a. While the height of the protrusions 25 is not particularly limited, the average height is preferably about 3 μm to 10 μm. Also, while the sectional diameter of the protrusions 25 in the direction parallel to the surface 22a is not particularly limited either, it is, for example, 1 to 50 μm.

The average height of the protrusions 25 can be determined, for example, by observing a section of the negative electrode current collector 22 in the thickness direction with a scanning electron microscope (SEM), measuring the heights of, for example, 100 protrusions 25, and calculating the average value from the measured values. The sectional diameter of the protrusions 25 can be determined in the same manner as the height of the protrusions 25. It should be noted that all the protrusions 25 do not need to have the same height or same sectional diameter.

Each of the protrusions 25 has an almost flat top face at the end in the growth direction. As used herein, the growth direction refers to the direction in which the protrusions 25 extend outwardly from the surface 22a of the negative electrode current collector 22. The flat top face of the protrusion 25 at the end enhances the adhesion between the protrusion 25 and the column 26. In terms of enhancing the bonding strength, it is more preferable that the flat top face at the end be almost parallel to the surface 22a.

The shape of the protrusions 25 is a circle. As used herein, the shape of the protrusions 25 refers to the shape of the protrusions 25 in an orthographic projection from a position vertically above the protrusions 25. The shape of the protrusions 25 is not limited to a circular shape, and may be, for example, polygonal, parallelogrammatic, trapezoidal, rhombic, or oval. The polygon is preferably a triangle to an octagon in consideration of production costs etc.

The number of the protrusions 25, the interval between the protrusions 25, and the like are not particularly limited and can be selected as appropriate, depending on, for example, the size (e.g., height and sectional diameter) of the protrusions 25 and the size of the columns 26 formed on the surfaces of the protrusions 25. The number of the protrusions 25 is, for example, approximately 10,000/cm² to 10,000,000/cm². Also, the preferable axis-to-axis distance of the adjacent protrusions 25 is approximately 2 to 100 μm. When the protrusions 25 are circular, the axis of each protrusion 25 is an imaginary line passing through the center of the circle and being perpendicular to the surface 22a. When the protrusions 25 are polygonal, parallelogrammatic, trapezoidal, or rhombic, the axis of each protrusion 25 is an imaginary line passing through the point of intersection of the diagonal lines and being perpendicular to the surface 22a. When the protrusions 25 are oval, the axis of each protrusion 25 is an imaginary line passing through the point of intersection of the major and minor axes and being perpendicular to the surface 22a.

The surface of each protrusion 25 may be provided with a bump (not shown). This can further increase the adhesion between the protrusion 25 and the column 26, thereby permitting more reliable prevention of separation of the column 26 from the protrusion 25, propagation of the separation, and the like. The bump protrudes outwardly from the surface of the protrusion 25. Two or more bumps smaller than the protrusion 25 may be formed. One or more bumps may be formed on a side face of the protrusion 25 so as to extend in the circumferential direction and/or growth direction of the protrusion 25. One or more bumps may be formed on the flat top face of the protrusion 25.

The bumps can be formed, for example, by a photoresist method or plating. For example, the bumps are formed by forming protrusions larger than the design dimensions of the protrusions 25 and etching the protrusions by using a photoresist. Also, the bumps are formed by partially plating the surfaces of the protrusions 25.

The negative electrode current collector 22 can be produced by utilizing a technique for roughening the surface of a metal sheet. Specifically, it can be produced using a roller with depressions corresponding to the protrusions 25 in shape, dimensions, and arrangement (hereinafter a “protrusion-forming roller”). As the metal sheet, for example, a metal foil or a metal film can be used. When the protrusions 25 are formed on one face of a metal sheet, a protrusion-forming roller and a roller with a flat surface are pressed against each other such that their axes are parallel, and the metal sheet is passed between the rollers and formed under pressure.

Also, when the protrusions 25 are formed on both faces of a metal sheet, two protrusion-forming rollers are pressed against each other such that their axes are parallel, and the metal sheet is passed between the rollers and formed under pressure. The pressure applied to the rollers can be selected as appropriate, depending on the material and thickness of the metal sheet, the shape and dimensions of the protrusions 25, the desired thickness of the pressed metal sheet, i.e., negative electrode current collector 22, etc.

The protrusion-forming roller can be produced, for example, by forming depressions corresponding to the protrusions 25 (shape, dimensions, and arrangement) at predetermined positions on the surface of a ceramic roller. The ceramic roller can include a core roller and a thermal spray layer. The core roller can be an iron roller, a stainless steel roller, or the like. The thermal spray layer is formed by evenly spraying a molten ceramic material such as chromium oxide onto the surface of the core roller. The thermal spray layer is provided with depressions. The depressions are formed using a laser which is commonly used to work ceramic materials etc.

A protrusion-forming roller in another embodiment includes a core roller, a base layer, and a thermal spray layer. The core roller is the same as that of the ceramic roller. The base layer is a resin layer formed on a surface of the core roller, and depressions are formed in a surface of the base layer. Synthetic resin forming the base layer preferably has high mechanical strength, and examples include thermosetting resins such as unsaturated polyester, thermosetting polyimides, and epoxy resins, thermoplastic resins such as polyamides, polyether ketone, polyether ether ketone, and fluorocarbon resin.

The base layer is formed by preparing a resin sheet with depressions on one face and bonding the face of the resin sheet having no depressions to a surface of the core roller. The thermal spray layer is formed by spraying a molten ceramic material such as chromium oxide onto the surface of the base layer with the depressions. It is thus preferable to form the depressions in the base layer so that the depressions are larger than the designed dimensions of the protrusions 25 by the thickness of the thermal spray layer.

A protrusion-forming roller in another embodiment includes a core roller and a cemented carbide layer. The core roller is the same as that of the ceramic roller. The cemented carbide layer is formed on a surface of the core roller and includes cemented carbides such as tungsten carbide. The cemented carbide layer can be formed by preparing a cemented carbide cylinder and fitting it to the core roller by expansion fit or shrink fit. In expansion fit, the cemented carbide cylinder is heated for expansion, and the core roller is inserted into the expanded cylinder. In shrink fit, the core roller is cooled for shrinkage, and the shrunk core roller is inserted into the cemented carbide cylinder. The surface of the cemented carbide layer is provided with depressions by laser machining.

A protrusion-forming roller in another embodiment is prepared by forming depressions in a surface of a hard iron based roller by laser machining. Hard iron based rollers are used to roll metal foil. Examples of hard iron based rollers include rollers made of high speed steel and forged steel. High speed steel is an iron-based material which is prepared by adding metals such as molybdenum, tungsten, and vanadium and applying a heat treatment to increase the hardness. Forged steel is an iron based material which is prepared by heating a steel ingot or billet, forging it with a press and a hammer or rolling and forging it, and heat treating it. A steel ingot is prepared by pouring molten steel into a mold. A steel billet is prepared from a steel ingot.

As illustrated in FIG. 1, the negative electrode active material layer 23 is formed as an aggregate of the plurality of columns 26 extending outwardly from the surfaces of the protrusions 25 of the negative electrode current collector 22. Usually, one column 26 is formed on one protrusion 25. The column 26 extends in the direction perpendicular to the surface 22a of the negative electrode current collector 22 or slantwise relative to the direction perpendicular thereto. Also, the plurality of columns 26 are spaced apart from one another, with gaps between the adjacent columns 26. These gaps reduce the stress created by the expansion and contraction upon charge/discharge, thereby suppressing the separation of the negative electrode active material layer 23 from the protrusions 25, the deformation of the negative electrode current collector 22, and the like.

Each of the columns 26 is preferably formed by laminating a plurality of columnar pieces. The column 26 illustrated in FIG. 3 is a laminate of eight columnar pieces 26a, 26b, 26c, 26d, 26e, 26f, 26g, and 26h. Although eight columnar pieces are laminated in this embodiment, the number of columnar pieces laminated is not limited to this, and any number of columnar pieces can be laminated to form a column.

The column 26 illustrated in FIG. 3 is formed as follows. First, the columnar piece 26a is formed so as to cover the top face of the protrusion 25 and an adjacent part of the side face. The columnar piece 26b is then formed so as to cover the remaining part of the side face of the protrusion 25 and a part of the top face of the columnar piece 26a. In FIG. 3, the columnar piece 26a is formed on one side of the protrusion 25 so as to include the top face, and the columnar piece 26b is formed on the other side of the protrusion 25 while partially overlapping with the columnar piece 26a.

Further, the columnar piece 26c is formed so as to cover the remaining part of the top face of the columnar piece 26a and a part of the top face or the columnar piece 26b. That is, the columnar piece 26c is formed so that it mainly contacts the columnar piece 26a. Further, the columnar piece 26d is formed so that it mainly contacts the columnar piece 26b. Likewise, the columnar pieces 26e, 26f, 26g, and 26h are alternately laminated in a zigzag to form the column 26.

The columns 26 can be formed by an electron beam deposition device 30 illustrated in FIG. 4. In FIG. 4, the respective components in the deposition device 30 are also illustrated by the solid lines. The deposition device 30 includes a chamber 31, a first pipe 32, a fixing table 33, a nozzle 34, a target 35, an electron beam generator (not shown), a power source 36, and a second pipe (not shown). The chamber 31 is a pressure-resistant container which contains the first pipe 32, the fixing table 33, the nozzle 34, and the target 35. One end of the first pipe 32 is connected to the nozzle 34, and the other end is connected via a massflow controller (not shown) to a raw material gas cylinder or raw material gas production device (not shown) placed outside the chamber 31. Oxygen, nitrogen, and the like can be used as the raw material gas. Through the first pipe 32, the raw material gas is supplied to the nozzle 34.

The fixing table 33 is a plate supported rotatably, and the negative electrode current collector 22 can be fixed to one face (fixing face) of the fixing table 33 in the thickness direction. The fixing table 33 is rotated between the position shown by the solid line and the position shown by the dash-dotted line. When the fixing table 33 is at the position shown by the solid line, the fixing face of the fixing table 33 faces the nozzle 34, and the angle formed between the fixing table 33 and a horizontal line is α°. When the fixing table 33 is at the position shown by the dash-dotted line, the fixing face of the fixing table 33 faces the nozzle 34, and the angle formed between the fixing table 33 and a horizontal line is (180−α)°. The angle α° can be selected as appropriate, depending on the dimensions of the columns 26 and the like.

The nozzle 34 is disposed vertically between the fixing table 33 and the target 35 and connected to one end of the first pipe 32. Through the nozzle 34, the raw material gas is supplied into the chamber 31. The target 35 contains a raw material such as silicon or tin. The electron beam generator emits an electron beam to the target 35, to generate the vapor of the raw material. The power source 36, which is disposed outside the chamber 31, applies a voltage to the electron beam generator. The second pipe is used to fill the chamber 31 with a gas. An electron beam deposition device with the same structure as that of the deposition device 30 is commercially available, for example, from ULVAC, Inc.

When using, for example, silicon as the raw material and oxygen as the raw material gas, the electron beam deposition device 30 is operated as follows. First, the negative electrode current collector 22 is fixed to the fixing table 33, and oxygen is introduced into the chamber 31. Then, the target 35 is irradiated with an electron beam to generate silicon vapor. The silicon vapor rises vertically upward, and mixes with oxygen near the nozzle 34 to form a mixed gas. The mixed gas further rises and is supplied to the surface of the negative electrode current collector 22. As a result, a layer including silicon and oxygen is formed on the surfaces of the protrusions 25. At this time, by setting the fixing table 33 at the position shown by the solid line, the columnar piece 26a illustrated in FIG. 3 is formed on the surface of each protrusion 25. Next, by rotating the fixing table 33 to the position shown by the dash-dotted line, the columnar piece 26b illustrated in FIG. 3 is formed. In this way, by alternately rotating the fixing table 33, the columns 26 each of which is a laminate of the eight columnar pieces 26a, 26b, 26c, 26d, 26e, 26f, 26g, and 26h are formed on the surfaces of the protrusions 25 at one time.

When the alloy-type negative electrode active material is, for example, a silicon oxide represented by SiOₐ where 0.05<a<1.95, the columns 26 may be formed so that there is an oxygen concentration gradient in the thickness direction of the columns 26. Specifically, the columns 26 may be formed so that the oxygen content is high near the negative electrode current collector 22 and that the oxygen content lowers as the distance from the negative electrode current collector 22 increases. This can further enhance the adhesion between the protrusions 25 and the columns 26.

It should be noted that when the raw material gas is not supplied from the nozzle 34, the columns 26 composed mainly of elemental silicon or tin are formed.

The lithium ion secondary battery of the invention can be used in the same applications as conventional lithium ion secondary batteries, and in particular, is useful as the power source for portable electronic devices such as personal computers, cell phones, mobile devices, portable digital assistants (PDAs), portable game machines, and video cameras. Also, the lithium ion secondary battery of the invention is expected to be used, for example, as the main power source or auxiliary power source for electric motors in hybrid electric vehicles, electric vehicles and fuel cell cars, the power source for power tools, vacuum cleaners, and robots, and the power source for plug-in HEVs.

The invention is hereinafter described specifically by way of Examples, and Comparative Examples.

### Example 1

### (1) Preparation of Positive Electrode Active Material

A cobalt sulfate and an aluminum sulfate were added to an aqueous solution of NiSO₄ such that Ni:Co:Al=7:2:1 (molar ratio), to prepare an aqueous solution with a metal ion concentration of 2 mol/L. While this aqueous solution was being stirred, a 2 mol/L sodium hydroxide solution was added dropwise for neutralization, to obtain a ternary precipitate with the composition represented by Ni_{0.7}Co_{0.2}Al_{0.1}(OH)₂ by coprecipitation. This precipitate was filtered out, washed with water, and dried at 80° C. to obtain a composite hydroxide. The mean particle size of the composite hydroxide was measured with a particle size distribution analyzer (trade name: MT3000, available from Nikkiso Co., Ltd.). As a result, the mean particle size was found to be 10 μm.

This composite hydroxide was heated at 900° C. in air for 10 hours, to obtain a ternary composite oxide with the composition represented by Ni_{0.7}Co_{0.2}Al_{0.1}O. The ternary composite oxide was mixed with lithium hydroxide monohydrate such that the sum of the number of Ni, Co, and Al atoms was equal to the number of Li atoms. The resultant mixture was heated at 800° C. in air for 10 hours, to obtain a lithium nickel containing composite metal oxide with the composition represented by LiNi_{0.7}Co_{0.2}Al_{0.1}O₂. This lithium nickel containing composite metal oxide was analyzed by powder X-ray diffraction. As a result, it was found to have a monophase hexagonal layer structure with Co and Al dissolved in the form of solid solution. In this way, a positive electrode active material having a mean secondary particle size of 10 μm and a BET specific surface area of 0.45 m²/g was obtained.

### (2) Preparation of Positive Electrode

A positive electrode mixture slurry was prepared by sufficiently mixing 100 g of the positive electrode active material thus obtained, 3 g of acetylene black (conductive agent), 3 g of polyvinylidene fluoride powder (binder), and 50 ml of N-methyl-2-pyrrolidone (NMP). This positive electrode mixture slurry was applied onto one face of a 20-μm thick aluminum foil (positive electrode current collector), followed by drying. Thereafter, the slurry was applied onto the other face, dried, and rolled. In this way, the positive electrode active material layers were formed. The positive electrode was then cut to a size of 50 mm×79 mm, and one end thereof was provided with a 10 mm square area for attaching a lead. In the positive electrode thus obtained, the positive electrode active material layer carried on one face of the aluminum foil had a thickness of 60 μm. The active material layer in the area for attaching a lead was peeled off, and a positive electrode lead was attached thereto by ultrasonic welding.

### (3) Preparation of Negative Electrode

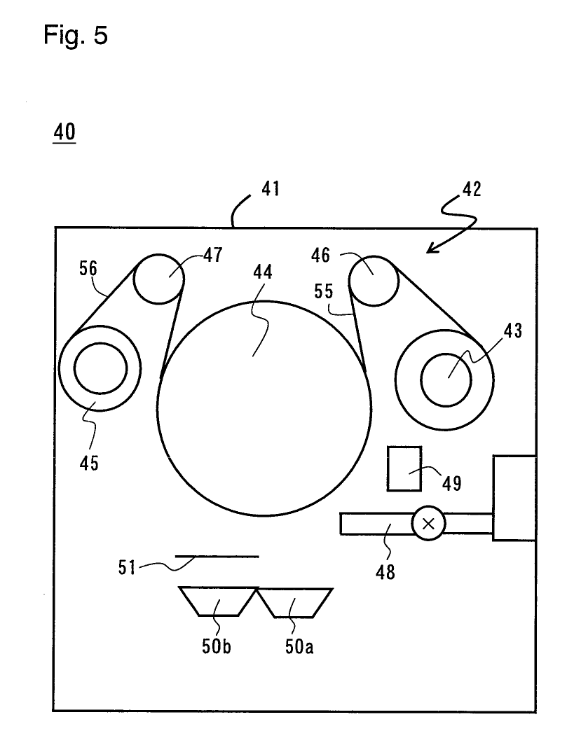

FIG. 5 is a schematic side view of the structure of a deposition apparatus 40 for forming a negative electrode active material layer. The deposition apparatus 40 includes a chamber 41, a transporting means 42, a gas supply means 48, a plasma-generating means 49, silicon targets 50a and 50b, a shield 51, and an electron beam heating means (not shown). The chamber 41 is a pressure-resistant container accommodating the transporting means 42, the gas supply means 48, the plasma-generating means 49, the silicon targets 50a and 50b, the shield 51, and the electron beam heating means.

The transporting means 42 includes a supply roller 43, a can 44, a take-up roller 45, and guide rollers 46 and 47. Each of the supply roller 43, the can 44, and the guide rollers 46 and 47 is disposed rotatably about the axis. A long negative electrode current collector 55 is wound around the supply roller 43. The can 44 is larger in diameter than the other rollers, and contains a cooling means (not shown) therein. When the negative electrode current collector 55 is transported on the surface of the can 44, the negative electrode current collector 55 is cooled. Thus, the vapor of the alloy-type negative electrode active material is cooled and deposited to form a thin film.

The take-up roller 45 is disposed rotatably about the axis by a driving means (not shown). One end of the negative electrode current collector 55 is fixed to the outer face of the take-up roller 45. When the take-up roller 45 is rotated, the negative electrode current collector 55 is transported from the supply roller 43 through the guide roller 46, the can 44, and the guide roller 47. A negative electrode 56 with the thin film of the alloy-type negative electrode active material formed on the surface of the negative electrode current collector 55 is rewound around the take-up roller 45.

The gas supply means 48 supplies a raw material gas such as oxygen or nitrogen into the chamber 41 in the case of forming a thin film composed mainly of an oxide, nitride, etc. of silicon or tin. The plasma generating means 49 makes the raw material gas supplied from the gas supply means 48 into plasmatic condition. The silicon targets 50a and 50b are used to form a thin film containing silicon. The shield 51 is positioned between the can 44 and the silicon targets 50a and 50b in the vertical direction and is horizontally movable. The position of the shield 51 in the horizontal direction is adjusted depending on the condition of the thin film that is being formed on the surface of the negative electrode current collector 55. The electron beam heating means irradiates the silicon target 50a, 50b with an electron beam to heat it and produce silicon vapor.

Using the deposition apparatus 40, a negative electrode active material layer (silicon thin film) with a thickness of 8 μm was formed on the surface of the negative electrode current collector 55 under the following conditions.

Pressure inside chamber 41: 8.0×10⁻⁵ Torr

Negative electrode current collector 55:

electrolytic copper foil with a thickness of 35 μm (available from Furukawa Circuit Foil Co., Ltd.)

Rewinding speed of negative electrode 56 by take-up roller 45 (transportation speed of negative electrode current collector 55): 2 cm/min

Raw material gas: Not supplied

Targets 50a and 50b: silicon monocrystal with a purity 99.9999% (available from Shin-Etsu Chemical Co., Ltd.)

Acceleration voltage of electron beam: −8 kV

Emission of electron beam: 300 mA

The resultant negative electrode 56 was cut to 55 mm×85 mm, and one end thereof was provided with a 10 mm square area for attaching a lead to produce a negative electrode plate. Lithium metal was deposited on the surface of the negative electrode active material layer of this negative electrode plate. By depositing the lithium metal, lithium corresponding to the irreversible capacity to be stored in the initial charge/discharge was added to the negative electrode active material layer. The deposition was performed in an argon atmosphere, using a resistance heating deposition device (available from ULVAC, Inc.). A tantalum boat in the resistance heating deposition device was charged with lithium metal, and the negative electrode was fixed so that the negative electrode active material layer faced the tantalum boat. The tantalum boat was supplied with a current of 50 A in an argon atmosphere, and the deposition was performed for 10 minutes. The resultant negative electrode plate had a tensile strength of 10.2 N/mm and a tensile elongation rate of 8.2%

### (4) Preparation of Non-Aqueous Electrolyte

A non-aqueous electrolyte was prepared by dissolving LiPF₆ at a concentration of 1.0 mol/L in a solvent mixture of ethylene carbonate and ethyl methyl carbonate in a volume ratio of 1:1.

### (5) Production of Lithium Ion Secondary Battery

An electrode unit was produced by stacking the positive electrode plate, a polyethylene micro-porous film (separator, trade name: Hipore, thickness 20 μm, available from Asahi Kasei Corporation), and the negative electrode plate such that the positive electrode active material layer faced the negative electrode active material layer with the polyethylene micro-porous film interposed therebetween. A stacked electrode assembly was produced by stacking 9 electrode units in series with a separator (Hipore) interposed between each pair of the electrode units. Aluminum positive electrode leads with polypropylene tabs and nickel negative electrode leads with polypropylene tabs were attached to this stacked electrode assembly, which was then inserted into a housing made of an aluminum laminate film. The polypropylene tabs were disposed at a sealing area and thermally adhered thereto. Thereafter, the non-aqueous electrolyte was injected into the housing. While the housing was being evacuated, the opening of the housing was sealed to produce a lithium ion secondary battery.

### (6) Initial Charge/Discharge Under Pressure

While the lithium ion secondary battery was being pressed, an initial charge/discharge was performed to obtain a lithium ion secondary battery of the invention. The pressing conditions were a temperature of 25° C. and a pressure of 2×10⁵ N/m². Using a press machine whose pressing plane is larger than the entire surface of the stacked electrode assembly in the thickness direction, the entire surface in the thickness direction was evenly pressed. Also, the initial charge/discharge conditions are as follows.

At an ambient temperature of 25° C., the battery was charged at a constant current of an hour rate of 0.2 C (240 mA) relative to design capacity (1200 mAh) until the battery voltage reached 4.2 V, and then charged at a constant voltage of 4.2 V until the current value decreased to an hour rate of 0.05 C (60 mA). The battery was then allowed to stand for 20 minutes. Thereafter, the battery was discharged at a constant current of an hour rate of 0.2 C (240 mA) until the battery voltage decreased to 2.5 V. After the completion of the charge/discharge, the pressing was stopped.

### Example 2

A lithium ion secondary battery was produced in the same manner as in Example 1 except that the production method of the negative electrode was changed as follows. The resultant negative electrode plate had a tensile strength of 10.5 N/mm and a tensile elongation rate of 1.5%

### (Production of Negative Electrode)

A ceramic layer with a thickness of 100 μm was formed by spraying molten chromium oxide on the surface of an iron roller with a diameter of 50 mm. Circular holes (depressions) with a diameter of 12 μm and a depth of 8 μm were formed in the surface of the ceramic layer by laser machining, to produce a protrusion-forming roller. These holes were formed in the close-packed arrangement at an axis-to-axis distance of adjacent holes of 20 μm. The bottom of each hole was substantially flat in the central part thereof, and the corner formed by the edge of the bottom and the side face of the hole was rounded.

A copper alloy foil containing 0.03% by weight of zirconium relative to the whole amount (trade name: HCL-02Z, thickness 20 μm, available from Hitachi Cable Ltd.) was heated at 600° C. in an argon gas atmosphere for 30 minutes for annealing. This copper alloy foil was passed between two protrusion-forming rollers pressed against each other at a linear load of 2 t/cm, so that both faces of the copper alloy foil were pressed. In this way, a negative electrode current collector used in the invention was prepared. A cross-section of the negative electrode current collector in the thickness direction thereof was observed with a scanning electron microscope, and the negative electrode current collector was found to have a plurality of protrusions on the surface. The average height of the protrusions was about 8 μm.

A negative electrode active material layer was formed on the protrusions on a surface of the negative electrode current collector, using a commercially available deposition device (available from ULVAC, Inc.) with the same structure as the electron beam deposition device 30 of FIG. 4. The deposition conditions were as follows. The fixing table with the 100 mm×185 mm negative electrode current collector fixed thereon was alternately rotated between the position at which angle α=60° (the position shown by the solid line in FIG. 4) and the position at which angle (180−α)=120° (the position shown by the dashed line in FIG. 4). In this way, a plurality of columns each composed of a laminate of eight columnar pieces as illustrated in FIG. 3 were formed. Each column was grown from the top face of the protrusion and the side face near the top face in the extending direction of the protrusion.

Raw material of negative electrode active material (evaporation source): silicon, purity 99.9999%, available from Kojundo Chemical Laboratory Co., Ltd

Oxygen released from nozzle: purity 99.7%, available from Taiyo Nippon Sanso Corporation

Flow rate of oxygen released from nozzle: 80 sccm

Angle α: 60°

Acceleration voltage of electron beam: −8 kV

Emission: 500 mA

Deposition time: 3 minutes

The thickness of the negative electrode active material layer composed of a plurality of columns was 16 μm. The thickness of the negative electrode active material layer was obtained by observing a cross-section of the negative electrode in the thickness direction thereof with a scanning electron microscope, selecting 10 columns formed on the surfaces of the protrusions, measuring the length from the vertex of each protrusion to the vertex of the columns, and averaging the 10 measured values. Also, the amount of oxygen contained in the negative electrode active material layer was quantified by a combustion method, and the composition of the compound constituting the negative electrode active material layer was SiO_{0.5}. In the same manner as described above, an active material layer was formed on the other face of the current collector from the face on which the active material layer was formed in the above manner, to obtain a negative electrode with the active material layers formed on both sides of the current collector.

Thereafter, lithium metal was deposited on the surface of each negative electrode active material layer, so that lithium corresponding to the irreversible capacity to be stored in the initial charge/discharge was added to the negative electrode active material layer. The deposition was performed in an argon atmosphere, using a resistance heating deposition device (available from ULVAC, Inc.). A tantalum boat in the resistance heating deposition device was charged with lithium metal, and the negative electrode was fixed so that the negative electrode active material layer faced the tantalum boat. The tantalum boat was supplied with a current of 50 A in an argon atmosphere, and the deposition was performed for 10 minutes. This deposition was also performed on both sides of the negative electrode. This negative electrode was cut to 55×85 mm.

### Comparative Example 1

A lithium ion secondary battery was produced in the same manner as in Example 1 except that pressing was not performed in the initial charge/discharge.

### (Battery Capacity Evaluation)

Using the lithium ion secondary batteries of Examples 1 to 2 and Comparative Example 1, the following charge/discharge cycle was repeated three times, and the discharge capacity at the 3^{rd} cycle was obtained. The results are shown in Table 1.

Constant current charge: 240 mA, cut-off voltage 4.2 V.

Constant voltage charge: 4.2 V, cut-off current 60 mA, stand-by time 20 minutes.

Constant current discharge: current 240 mA, cut-off voltage 2.5 V, stand-by time 20 minutes.

### (Charge/Discharge Cycle Characteristics)

In a 25° C. environment, the lithium ion secondary batteries of Examples 1 to 2 and Comparative Example 1 were charged to 4.2 V at a constant current of 800 mA and then discharged to 2.5 V at a constant current of 800 mA, and this cycle was repeated. After 50 cycles, the batteries were range of 4.2 V to 2.5 V, and the discharge capacity at 0.2 C was obtained. The percentage of the discharge capacity at 0.2 C after 50 cycles relative to the initial discharge capacity at 0.2 C was obtained as capacity retention rate (%). The results are shown in Table 1.

### (Change of Battery Thickness)

After the initial charge/discharge is performed, the battery thickness T₀ during a charge at the 2^{nd} charge/discharge cycle was measured. Further, the battery thickness T in charged state at the 52^{nd} charge/discharge cycle was measured, to obtain the rate of increase of thickness of the battery corresponding to the rate of increase of the thickness of the stacked electrode assembly. Table 1 shows the results.

TABLE 1

| | | | Rate of |
|---|---|---|---|
| | | Capacity | increase of |
| | Discharge | retention | battery |
| | capacity | rate | thickness |
| | (mAh) | (%) | (%) |
| Example 1 | 1163 | 95 | 8% |
| Example 2 | 1263 | 95 | 5% |
| Comparative | 1063 | 94 | 17% |
| Example 1 | | | |

From Table 1, it has been confirmed that the batteries of the invention obtained by performing an initial charge/discharge under pressure do not suffer degradation of battery performance such as discharge capacity and cycle characteristics even after repeated charge/discharge, and that an increase in battery thickness is suppressed. The increase in battery thickness after repeated charge/discharge is thought to occur due to buckling (deformation) of the electrode assembly. It is therefore clear that the invention can suppress the deformation of the electrode assembly.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A lithium ion secondary battery comprising a stacked electrode assembly that comprises electrode units stacked with a separator interposed between each pair of the electrode units,
each of the electrode units comprising a positive electrode, a separator, and a negative electrode stacked in the thickness direction,
the positive electrode including a positive electrode active material layer containing a positive electrode active material capable of absorbing and desorbing lithium and a positive electrode current collector,
the negative electrode including a thin-film negative electrode active material layer comprising an alloy-type negative electrode active material and a negative electrode current collector,
wherein a rate of increase of the thickness of the stacked electrode assembly due to a predetermined number of charge and discharge cycles is equal to or less than 10%.

2. The lithium ion secondary battery in accordance with claim 1, wherein the rate of increase of the thickness of the stacked electrode assembly is 0.3% to 10%.

3. The lithium ion secondary battery in accordance with claim 1, wherein an initial charge and an initial discharge are performed with the stacked electrode assembly pressed.

4. The lithium ion secondary battery in accordance with claim 1, wherein the initial charge and the initial discharge are performed under a pressure of 1.0×10⁴ N/m² to 5.0×10⁶ N/m².

5. The lithium ion secondary battery in accordance with claim 1, wherein the number of the electrode units stacked is 2 to 100.

6. The lithium ion secondary battery in accordance with claim 1, wherein the negative electrode has a tensile strength of 3 N/mm or more and a tensile elongation rate of 0.05% or more.

7. The lithium ion secondary battery in accordance with claim 1, wherein the thin-film negative electrode active material layer is formed by evaporation, chemical vapor deposition, or sputtering.

8. The lithium ion secondary battery in accordance with claim 1, wherein the thin-film negative electrode active material layer has a thickness of 3 μm to 30 μm.

9. The lithium ion secondary battery in accordance with claim 1, wherein the thin-film negative electrode active material layer comprises a plurality of columns, and the columns contain the alloy-type negative electrode active material and extend outwardly from a surface of the negative electrode current collector.

10. The lithium ion secondary battery in accordance with claim 1, wherein the alloy-type negative electrode active material is at least one selected from the group consisting of silicon, silicon oxides, silicon nitrides, silicon alloys, silicon compounds, tin, tin oxides, tin alloys, and tin compounds.

11. A method for producing a lithium ion secondary battery, comprising the steps of:
(a) stacking a positive electrode, a separator, and a negative electrode in this order in the thickness direction, thereby to form an electrode unit, the positive electrode including a positive electrode active material layer containing a positive electrode active material capable of absorbing and desorbing lithium and a positive electrode current collector, the negative electrode including a thin-film negative electrode active material layer comprising an alloy-type negative electrode active material and a negative electrode current collector;
(b) stacking a plurality of electrode units produced in the above manner with a separator interposed between each pair of the electrode units, thereby to form a stacked electrode assembly; and
(c) performing an initial charge and an initial discharge while pressing the stacked electrode assembly.

12. The method for producing a lithium ion secondary battery in accordance with claim 11, wherein in the step (c), the stacked electrode assembly is pressed by a pressure of 1.0×10⁴ N/m² to 5.0×10⁶ N/m².

13. The method for producing a lithium ion secondary battery in accordance with claim 11, wherein the number of the electrode units stacked is 2 to 100.

14. The method for producing a lithium ion secondary battery in accordance with claim 11, wherein the negative electrode has a tensile strength of 3 N/mm or more and a tensile elongation rate of 0.05% or more.

15. The method for producing a lithium ion secondary battery in accordance with claim 11, wherein the thin-film negative electrode active material layer is formed by evaporation, chemical vapor deposition, or sputtering.

16. The method for producing a lithium ion secondary battery in accordance with claim 11, wherein the thin-film negative electrode active material layer has a thickness of 3 μm to 30 μm.

17. The method for producing a lithium ion secondary battery in accordance with claim 11, wherein the thin-film negative electrode active material layer comprises a plurality of columns, and the columns contain the alloy-type negative electrode active material and extend outwardly from a surface of the negative electrode current collector.

18. The method for producing a lithium ion secondary battery in accordance with claim 11, wherein the alloy-type negative electrode active material is at least one selected from the group consisting of silicon, silicon oxides, silicon nitrides, silicon alloys, silicon compounds, tin, tin oxides, tin alloys, and tin compounds.

19. A lithium ion secondary battery produced by the production method of claim 11.
